(19) United States
(12) Patent Application Publication
(10) Pub. No.: US 2010/0329645 A1
(43) Pub. Date: Dec. 30, 2010

(54) PROGRAM RECORDING APPARATUS AND PROGRAM RECORDING METHOD

(76) Inventor: Tatsuro Sakamoto, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/817,885

(22) Filed: Jun. 17, 2010

(30) Foreign Application Priority Data
Jun. 30, 2009 (JP) 2009-156272

(51) Int. Cl. H04N 5/00

(52) U.S. Cl. 386/297; 386/E05.003; 386/281; 386/234

(57) ABSTRACT

According to one embodiment, a program recording apparatus is provided, which includes a storage configured to hold files, a console module configured to select a program when operated, a reception processing circuit configured to play back the program selected at the console module, while receiving the program, a presence detection sensor configured to detect a non-viewed state in which the program being played back by the reception processing circuit is not viewed, and a recording controller configured to record the program selected, as a file, in the storage, and to erase the file of the program from the storage if the program is confirmed not set to a non-viewed state before the program comes to an end.

### CROSS-REFERENCE TO RELATED APPLICATIONS

This application is based upon and claims the benefit of priority from Japanese Patent Application No. 2009-156272, filed Jun. 30, 2009; the entire contents of which are incorporated herein by reference.

### FIELD

Embodiment described herein relate generally to a program recording apparatus and a program recording method.

### BACKGROUND

In recent years, television receivers have acquired more and more functions. Some types of television receivers incorporate, for example, a hard disk drive. In such a television receiver, any program selected on the electronic program guide can be first reserved and then video-recorded on the hard disk, and the program a viewer is now watching can be also recorded on the hard disk.

Such a television receiver is disclosed in, for example, Jpn. Pat. Appln. KOKAI Publication No. 2006-74434.

If the technique described in Publication No. 2006-74434 is used, however, a time lag occurs between the moment the viewer leaves the region and the moment the recording is started. Consequently, the program part broadcast during the time lag is missing in the program recorded.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary diagram showing the configuration of a television receiver according to an embodiment;

FIG. 2 is an exemplary diagram showing a viewing area that scanned by a presence detection sensor shown in FIG. 1;

FIG. 3 is an exemplary diagram showing how commands are processed in the microprocessor shown in FIG. 1;

FIG. 4 is an exemplary diagram explaining the process of registering/deleting any program not to be missed, as is illustrated in FIG. 3;

FIG. 5 is an exemplary diagram showing the menu that is displayed as the remote controller (FIG. 1) is operated; and

FIG. 6 is an exemplary diagram showing a remote controller that has a presence detection sensor of the type shown in FIG. 1.

### DETAILED DESCRIPTION

Various embodiments will be described hereinafter with reference to the accompanying drawings.

In general, according to one embodiment, a program recording apparatus includes a storage configured to hold files; a console module configured to select a program when operated; a reception processing circuit configured to play back the program selected at the console module, while receiving the program; a presence detection sensor configured to detect a non-viewed state in which the program being played back by the reception processing circuit is not viewed; and a recording controller configured to record the program selected at the console module, as a file, in the storage, and to erase the file of the program from the storage if the program is confirmed not set to a non-viewed state before the program comes to an end.

A television receiver according to an embodiment will be described with reference to the accompanying drawings. The television receiver functions as a program recorder that receives and video-recording, for example, terrestrial analog broadcast programs, BS-broadcast programs, CS-broadcast programs and terrestrial digital broadcast programs.

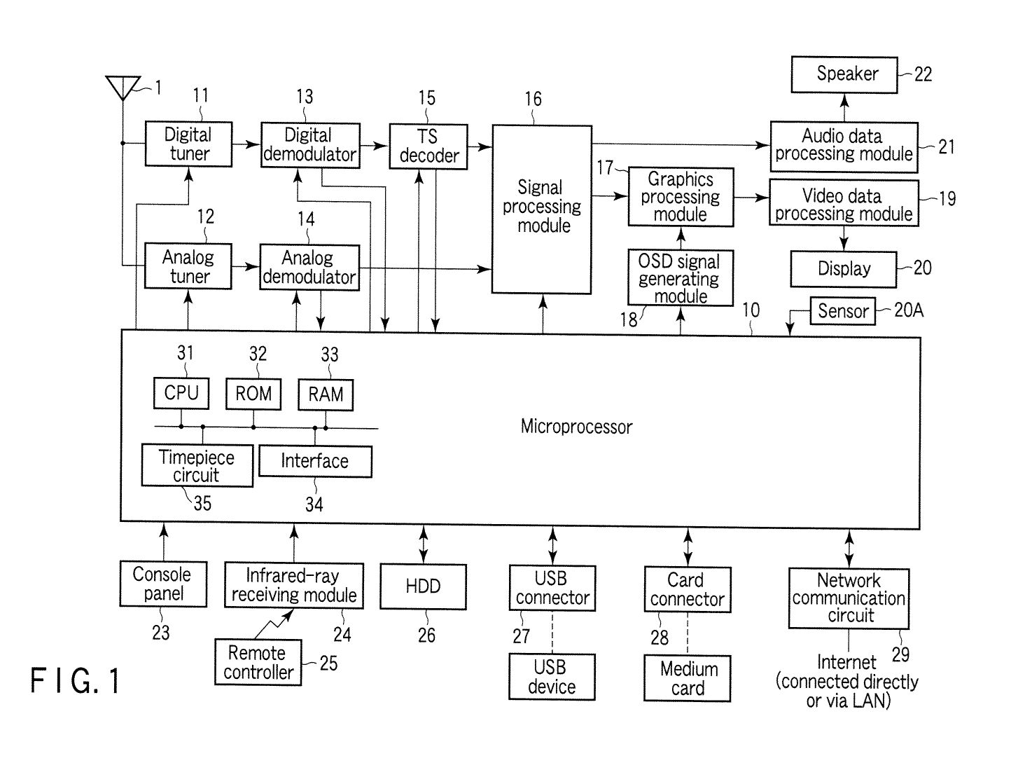

FIG. 1 is a diagram schematically showing an exemplary configuration of the television receiver. The television receiver has a microprocessor 10, a digital tuner 11, an analog tuner 12, a digital demodulator 13, an analog demodulator 14, and a TS decoder 15.

An antenna 1 receives broadcast signals, i.e., BS-broadcast, CS-broadcast and terrestrial digital broadcast waves, and supplies the broadcast signals to the digital tuner 11. The antenna 1 also receives terrestrial analog broadcast signals, i.e., terrestrial analog broadcast waves, and supplies the terrestrial analog broadcast signals to the analog tuner 12.

The digital tuner 11 and the analog tuner 12 select a broadcast wave each, by using the phase-locked loop (PLL) system. That is, the digital tuner 11 and the analog tuner 12 selects any desired broadcast wave on the basis of reception parameters such as the intermediate frequency and band width designated under the control of the microprocessor 10.

The digital tuner 11 supplies the signal coming from the station selected, to the digital demodulator 13. The digital demodulator 13 demodulates the signal by using, for example, the orthogonal frequency division multiplexing (OFDM) system. The digital demodulator 13 then supplies the signal, thus demodulated, to the TS decoder 15.

The TS decoder 15 decodes the signal received from the digital demodulator 13, generating a digital video signal and a digital audio signal. The TS decoder 15 supplies the digital video signal and digital audio signal to a signal processing module 16.

The analog tuner 12 supplies the received signal coming from the selected station, to the analog demodulator 14. The analog demodulator 14 demodulates the signal received from the analog tuner 12, generating an analog video signal and an analog audio signal. The analog demodulator 14 supplies the analog video signal and analog audio signal to the signal processing module 16.

The television receiver further has a signal processing module 16, a graphics processing module 17, an on-screen display (OSD) signal generating module 18, a video data processing module 19, a display 20, an audio data processing module 21, a speaker 22, a console panel 23, an infrared-ray receiving module 24, a remote controller 25, a hard disk drive (HDD) 26, a universal serial bus (USB) connector 27, a card connector 28, and a network communication circuit 29.

The signal processing module 16 performs a specific digital signal process on the digital video signal and digital audio signal received from the TS decoder 15. The signal processing module 16 outputs the video signal, thus processed, to the graphics processing module 17. The signal processing module 16 outputs the audio signal, thus processed, to the audio data processing module 21.

The signal processing module 16 converts the analog video signal and analog audio signal, both received from the analog demodulator 14, to a digital video signal and a digital audio signal, respectively. The signal processing module 16 performs a specific process on the digital video signal and digital audio signal, both generated by processing the analog video signal and the analog audio signal, respectively. The signal processing module 16 output the digital video signal, thus processed, to the graphics processing module 17, and the audio signal, thus processed, to the audio data processing module 21.

The graphics processing module 17 superimposes an OSD signal generated by the OSD signal generating module 18 on the digital video signal received from the signal processing module 16. The graphics processing module 17 outputs the digital video signal, now superimposed with the OSD signal, to the video data processing module 19.

The video data processing module 19 performs various adjustments, such as a size adjusting process, on the digital video signal received from the graphics processing module 17. That is, the video data processing module 19 processes the digital video signal, so that the display 20 may display an image represented by the video signal. The video data processing module 19 outputs the digital video signal, subjected to the size adjusting process, to the display 20.

The display 20 displays the image represented by the digital video signal it has received from the video data processing module 19.

The audio data processing module 21 performs various adjustments, such as volume adjustment, on the digital audio signal received from the signal processing module 16. That is, the audio data processing module 21 processes the digital audio signal, so that the speaker 22 may generate sound represented by the audio signal. The audio data processing module 21 outputs the audio signal, subjected to the volume adjustment, to the speaker 22.

The speaker 22 generates sound from the audio signal received from the audio data processing module 21.

In the television receiver, the components 11 to 22 constitute a reception processing circuit that playbacks a broadcast program while receiving the program.

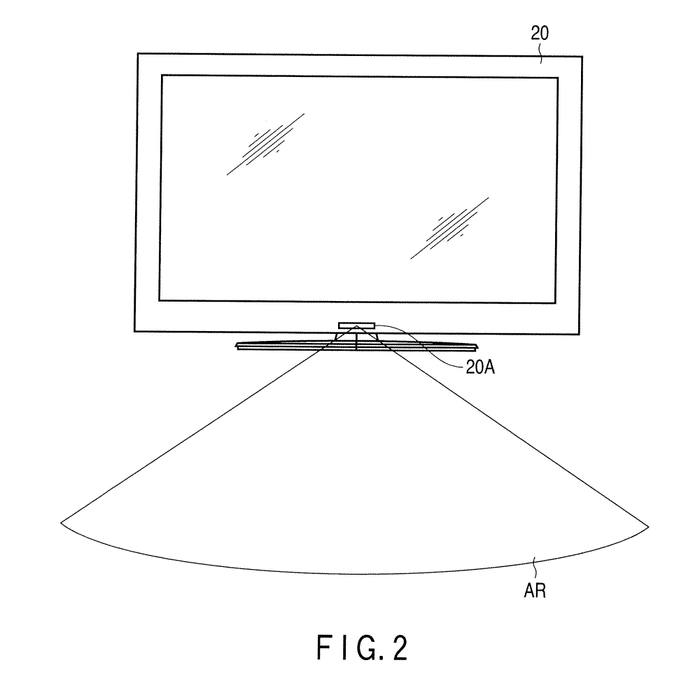

A presence detection sensor 20A is provided on the display 20, a little below the screen of the display 20A. The presence detection sensor 20A is an infrared sensor that has directivity. As shown in FIG. 2, the presence detection sensor 20A covers a viewing area AR existing in front of the display 20.

If the television receiver is set to a program-missing prevention mode, the presence detection sensor 20A periodically scans the viewing area AR for any viewer existing in the viewing area AR. If nobody is found in the viewing area AR, the presence detection sensor 20A detects a non-viewed state in which the program being broadcast is not viewed.

On detecting the non-viewed state, the presence detection sensor 20A causes the microprocessor 10 to perform an interruption process. In the interruption process, a non-viewed state flag is set in a specified area of the RAM 33 incorporated in the microprocessor 10. Even if a person exists in the viewing area AR, the presence detection sensor 20A detects the non-viewed state unless the person is sleeping and scarcely moves.

The program-missing prevention mode includes a recording mode in which any program is automatically recorded while being broadcast, so that a viewer who cannot keep viewing the program may later enjoy the program. Hereinafter, the recording of any program in the program-missing prevention mode will be referred to as “program-missing prevention recording.”

The microprocessor 10 receives commands input at the console panel 23 or the commands transmitted from the remote controller 25 and received by the infrared-ray receiving module 24. In accordance with the commands, the microprocessor 10 controls the components. The microprocessor 10 has a central processing unit (CPU) 31, a read only memory (ROM) 32, a random access memory (RAM) 33, an interface 34, and a timepiece circuit 35.

The CPU 31 performs various processes and various controls. The ROM 32 holds the control programs and various initial data items. The control programs are used in the CPU 31. The RAM 33 provides a work area that temporarily stores the data to input to the CPU 31 and also the data output from the CPU 31. The Interface 34 supplies and receives setting data and control data to and from the other components of the microprocessor 10 through, for example, an I2C bus. The timepiece circuit 35 manages the time data maintained corrected in accordance with the time-date data acquired from a broadcast wave or through a network.

The hard disk drive 26 holds the files of programs to be recorded by reservation or to be recorded starting the moment the viewer stops watching the screen. The hard disk drive 26 functions as a nonvolatile storage.

The USB connector 27 is used to connect various UBS devices to the television receiver. The card connector 28 is used to connect various medium cards to the television receiver. The network communication circuit 29 can be connected to the Internet, either directly or via a local area network (LAN).

The CPU 31 controls the OSD signal generating module 18, making the same to generate various menus that will be displayed on the screen of the display 20. The CPU 31 further records each broadcast program received, as a file, in storages such as the RAM 33 and the hard disk drive 26.

The CPU 31 erases the file of the broadcast program from the file if the presence detection sensor 20A does not detect a non-viewed state before the broadcast program comes to an end. In this case, the CPU 31 functions as recording controller.

The RAM 33 is used, for example, to hold a broadcast program being recorded from the moment the reception of the program started. The hard disk drive 26 is used to hold any broadcast program transferred from the RAM 33.

The CPU 31 transfers the broadcast program recorded in the RAM 33 to the hard disk drive 26 if the presence detection sensor 20A detects a non-viewed state before the broadcast program comes to an end. The CPU 31 further registers any recorded program in a record list.

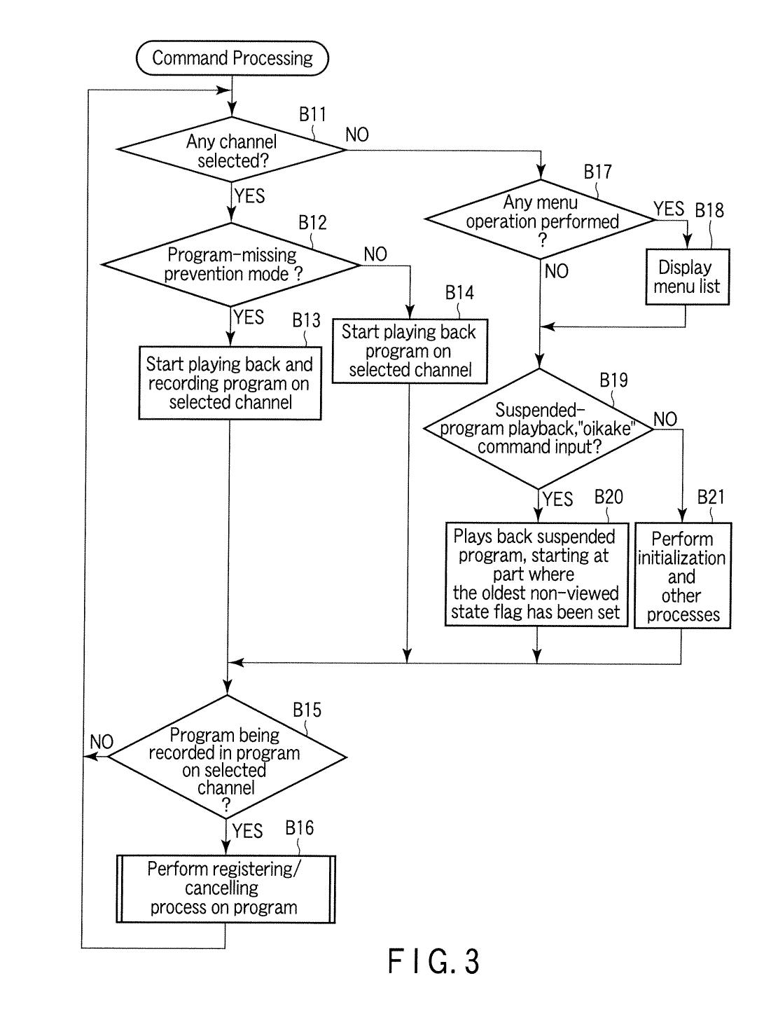

FIG. 3 is a diagram showing how commands are processed in the microprocessor 10 shown in FIG. 1. The microprocessor 10 processes upon the commands generated by the console panel 23 or the remote controller 25.

The CPU 31 determines, in Block B11, whether a channel has been selected.

If a channel has been selected, the CPU 31 determines, in Block B12, whether the television receiver is set to the program-missing prevention mode.

If the television receiver is set to the program-missing prevention mode, the CPU 31 starts, in Block B13, playing back and recording the program on the selected channel. The program is recorded as it is saved as a file in the RAM 33. While the program is being so recorded, the presence detection sensor 20A periodically scan the viewing area AR to detect whether or not a viewer exists in the viewing area AR.

If the presence detection sensor 20A detects a non-viewed state, the CPU 31 performs an interruption process, setting a non-viewed state flag in the specified area of the RAM 33. In the an interruption process, the non-viewed state flag is set, along with time data representing the time at which the non-viewing state is detected. The time data remains identical to the one first detected even if another non-viewed state flag is set later.

If the television receiver is not set to the program-missing prevention mode or if NO in Block B12, the CPU 31 starts playing back the program on the selected channel in Block B14.

In Block B15, the CPU 31 determines whether the television receiver is recording the program in the program-missing prevention mode. If the television receiver is not recording the program in the program-missing prevention mode, the CPU 31 returns to Block B11. If the television receiver is recording the program in the program-missing prevention mode, the CPU 31 performs a program registering and cancelling process on the program in Block B16, and then returns to Block B11.

If any channel is not found selected, in Block B11, the CPU 31 determines, in Block B17, whether any menu operation has been performed. If a menu operation has been made, the CPU 31 causes the display 20 to display a menu list, in Block B18. The CPU 31 then goes to Block B19. If no menu operation has been made, the CPU 31 goes directly to Block B19.

In Block B19, the CPU 31 determines whether a suspended-program playback “oikake” command has been input at the console panel 23 or the remote controller 25. If a suspended-program playback “oikake” command has been input, the CPU 31 plays back, in Block B20, the suspended program, starting at the part where the oldest non-viewed state flag has been set. If no non-viewed state flags have been set, the suspended will be played back from the first part. If no programs are being recorded, the CPU 31 will go to Block B15, without doing anything at all.

If no suspended-program playback “oikake” commands have been input, the CPU 31 will go to Block 21. In Block B21, the CPU 31 performs initialization and other processes, and goes to Block B15. The initialization is a process of setting various operating modes to the television receiver. The initialization includes, for example, the setting of program-missing prevention mode. The other processes include the input switching (i.e., switching between a broadcast program and the data coming from an external apparatus such as a game apparatus), the displaying of the electronic program guide, and the reservation of the recording of any desired programs.

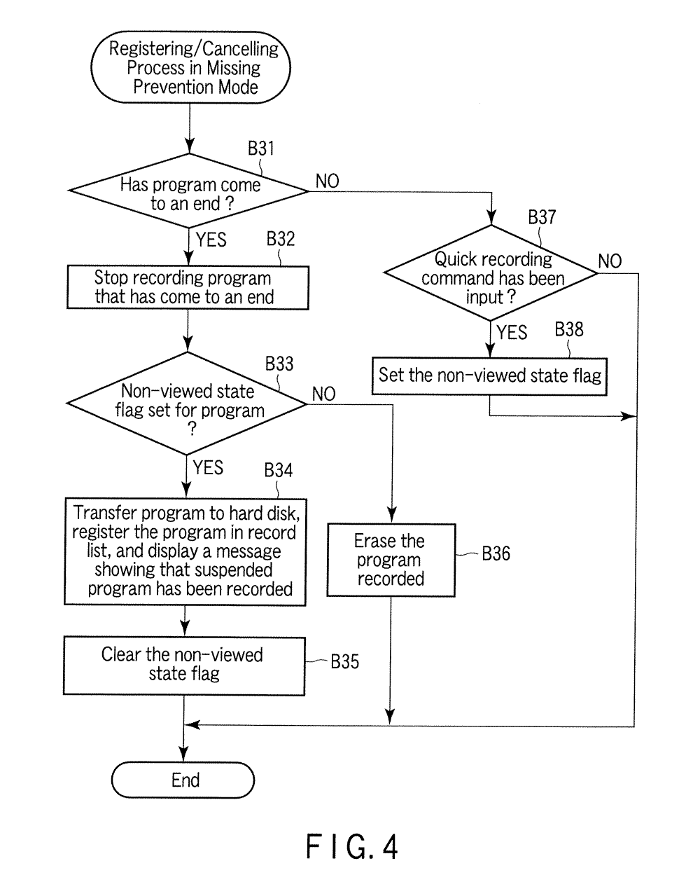

FIG. 4 is a diagram that explains, in detail, the program registering/cancelling process performed in Block B15 shown in FIG. 3. When the program registering/cancelling process is started, the CPU 31 determines, in Block B31, whether the program being recorded has come to an end as the broadcasting time allocated to this program passes. If the program has ended, the CPU 31 stops the recording of the program, in Block B32.

Then, the CPU 31 determines, in Block B33, whether non-viewed state flag has been set for the program that has just come to an end. If no non-viewed state flags have been set for the program, the CPU 31 erase the program recorded to its end in the RAM 33, in Block B36. On the other hand, if a non-viewed state flag has been set for the program, the CPU 31 transfers the program to the hard disk drive 26 and registers the program in the record list, in Block B34. Further, the CPU 31 causes the display 20 to display a message showing that the program the viewer has stopped viewing has been recorded.

In next Block B35, the CPU 31 clears the non-viewed state flag set for the program. When Block B35 of Block B36 is performed, the program registering/cancelling process is completed.

In Block B31, the program being recorded may not be found to have come to an end. In this case, the CPU 31 determines, in Block B37, whether a quick recording command has been input. If a quick recording command has been input, the CPU 31 sets a non-viewed state flag in Block B38, terminating the program registering/cancelling process. Note that the quick recording command is made while the program is being recorded, requesting for the saving the program. As a result, the CPU 31 keeps holding the broadcast program in the storage, not erasing the broadcast program.

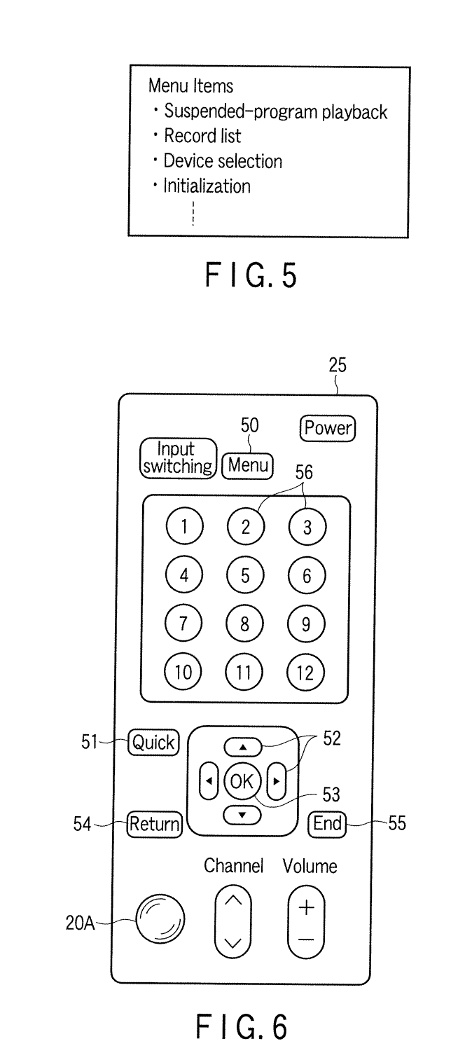

FIG. 5 is a diagram showing the menu table displayed when the remote controller shown in FIG. 1 is operated. The menu table shows at least “Suspended-program oikake Playback” and “Record List” as menu items. If the viewer operates the remote controller 25, selecting “Suspended-program oikake Playback,” the CPU 31 determines in Block B19 that a suspended-program playback “oikake” command has been input. If the viewer operates the remote controller 25, selecting “Record List,” the CPU 31 causes the display 20 to display the record list that shows all programs that have been registered.

FIG. 6 is a diagram showing a remote controller that has a presence detection sensor 20A of the same type as one provided on the display 20 as shown in FIG. 2. The presence detection sensor 20A provided on the remote controller 25 is a non-directional infrared sensor. Since a presence detection sensor is provided not only on the display 20, but also on the remote controller 25, the non-viewed state in which the broadcast program is not viewed can be more reliably detected. Nonetheless, only one presence detection sensor 20A may be provided on the display 20 or the remote controller 25.

The remote controller 25 includes a menu button 50, a quick record button 51, four cursor motion buttons (upward, downward, leftward and rightward) 52, an OK button 53, a “Return” button 54, an “End” button 55, and channel buttons 56, etc.

The menu button 50 is pushed to display, for example, the above-mentioned menu table on the screen of the display 20. The quick record button 51 is pushed to initiate the above-mentioned quick recording. Any one of the channel buttons 56 may be pushed to select the channel allocated to it.

To select any desired menu item shown in the menu, the user first pushes the cursor motion buttons 52, moving the cursor to the desired menu item included in the menu table displayed on the screen, and then pushes the OK button 53. To select, for example, the program-missing prevention mode, the user pushes the cursor motion buttons 52, moving the cursor to “Program-missing Prevention Mode” shown in the initial setting menu that is displayed by selecting “Initial Setting” included in the menu table displayed on the screen, and then pushes the OK button 53.

In this embodiment, any broadcast program received is recorded from the beginning, as a file, in the storage, and is erased from the storage when the program is confirmed not set to a non-viewed state before it comes to an end. Hence, even if the viewer leaves the viewing area AR in order to, for example, see a visitor, the broadcast program is continuously recorded from the beginning. As a result, the recorded program will have no missing parts.

This invention is not limited to the embodiment described above. Various changes and modifications can be made without departing from the scope and spirit of the invention.

The television receiver according to the embodiment has a display 20 that displays any broadcast program. Nonetheless, this invention may be applied to a video recorder that displays broadcast programs, by utilizing an external display. In this case, a nonvolatile storage, such as a hard disk drive, in which broadcast programs can be recorded and erased is incorporated in the video recorder.

The RAM 33 is a component that holds any broadcast program selected and recorded. The invention is not limited to this configuration. Rather, any broadcast program selected and recorded may be held in the hard disk drive 26. If this is the case, the broadcast program held in one area of the hard disk is moved to another area thereof and then registered in the record list, if the CPU 31 determines that the program has been set to a non-viewed state before it comes to its end.

In the embodiment described above, the broadcast program demodulated from any broadcast wave is recorded. Instead, a broadcast program stream-distributed through, for example, a network may be recorded.

As described above, a program being broadcast is selected as the console panel 23 or the remote controller 25 is operated in the embodiment described above, thereby selecting the channel allocated to the program. If the electronic program guide is displayed by the display 20, a desired program is selected from many programs shown in the electronic program guide.

If the source of input is switched from an external apparatus (e.g., game apparatus), back to the broadcasting stations, or if the power switch of the television receiver is turned on, the broadcast program on the channel selected last is selected again. This selection of program is achieved in, for example, one of the processes performed in Block B21. If a broadcast program is selected in this way, it is determined whether the television receiver is set to the program-missing prevention mode, as in Block B12, and then the program on the selected channel is played back and is recorded as in Block B13.

In the embodiment described above, the presence detection sensor 20A is an infrared sensor. The presence detection sensor 20A may be replaced by a sensor that does not use infrared rays in order to detect a non-viewed state of any broadcast program.

In the program recording apparatus and the program recording method, both described above, any program selected is recorded as a file in the storage, and will be erased from the storage if confirmed not set to a non-viewed state before it comes to an end. Hence, even if the viewer leaves the viewing area AR in order to, for example, see a visitor, the broadcast program is continuously recorded. As a result, the recorded program will have no missing parts.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. A program recording apparatus comprising:
a storage configured to hold files;
a console module configured to select a program when operated;
a reception processing circuit configured to play back the program selected at the console module, while receiving the program;
a presence detection sensor configured to detect a non-viewed state in which the program being played back by the reception processing circuit is not viewed; and
a recording controller configured to record the program selected at the console module, as a file, in the storage, and to erase the file of the program from the storage if the program is confirmed not set to a non-viewed state before the program comes to an end.

2. The program recording apparatus of claim 1, wherein the storage includes a RAM and a hard disk drive, and the recording controller transfers the program from the RAM to the hard disk drive, thereby registering the program in a record list, upon confirming that the program assumes the non-viewed state before coming to an end.

3. The program recording apparatus of claim 1, wherein the storage includes a hard disk drive, and the recording controller transfers the program from an area in the hard disk drive to another area in the hard disk drive, thereby registering the program in a record list, upon confirming that the program assumes the non-viewed state before coming to an end.

4. The program recording apparatus of claim 1, wherein the recording controller keeps the program saved in the storage, without erasing the program, after the program comes to an end, in accordance with a request for saving the program, which is made by the console module during the recording of the program.

5. The program recording apparatus of claim 1, wherein the recording controller plays back the program in accordance with a request for suspended-program playback, which is made by the console module during the recording of the program.

6. The program recording apparatus of claim 5, wherein the recording controller starts playing back the program in accordance with the request, at the time the presence detection sensor detects the non-viewed state for the first time.

7. The program recording apparatus of claim 1, wherein the recording controller causes a display to display, after the program comes to an end, a message showing that the program has been recorded.

8. The program recording apparatus of claim 1, wherein the recording controller causes a display to display, after the program comes to an end, a record list in which the program is registered, in response to a request made at the console module after the program comes to an end.

9. The program recording apparatus of claim 1, wherein the console module includes a remote controller having a non-directional infrared sensor uses as the presence detection sensor.

10. A program recording method comprising:
selecting a program;
playing back the program selected, while receiving the program;
recording the program selected at the console module, as a file, in the storage; and
erasing the file of the program if the program is confirmed not set to a non-viewed state before the program comes to an end.
